(19) United States
(12) Patent Application Publication
(10) Pub. No.: US 2017/0285720 A1
(43) Pub. Date: Oct. 5, 2017

(54) METHOD AND SYSTEM FOR MITIGATING TRANSMISSION CONGESTION VIA DISTRIBUTED COMPUTING AND BLOCKCHAIN TECHNOLOGY

(71) Applicant: Jigar Jayesh Shah, North Brunswick, NJ (US)

(72) Inventor: Jigar Jayesh Shah, North Brunswick, NJ (US)

(21) Appl. No.: 15/588,694

(22) Filed: May 7, 2017

(51) Int. Cl. G06F 1/32; G06Q 20/06

(52) U.S. Cl. CPC G06F 1/3206; G06Q 20/065; G06Q 20/0655; G06Q 20/3827

(57) ABSTRACT

A method and a system for mitigating transmission congestion are provided. The computer-implemented method uses distributed computing technology to convert electricity to useful work when determined beneficial to the electricity grid or grid assets. The method also includes an arrangement and prioritization of nodes to perform such work, whether located remotely or within a designated facility.

### BACKGROUND OF THE INVENTION

### Field of the Invention

The present invention relates to power transmission, blockchain, distributed computing, and locational marginal pricing.

### Prior Art

The advent of increased types of electricity generation sources connecting to the electric grid has allowed for a wider choice of pricing and sources of energy. For example, distributed wind turbines or solar photovoltaic energy sources often provide electricity at minimal operational costs after the outlay of the initial infrastructure. In the United States, for example, due to local or state governmental subsidies, the sales price of such energy sources often reach negative prices. However, existing transmission and distribution infrastructure is not designed to accommodate such new generation sources being brought online, whether renewable or not.

Due to large capital outlays and planning required to update or increase the capacity of energy grid infrastructure, readily adopting transmission lines to prioritize lower-priced, cleaner, or more convenient newer/increased capacity generation sources may be delayed or deemed impractical altogether. Transmission lines may reach capacity serving requested electricity demands from the grid via the desired generation sources, such that undesirable generation sources closer to the demand may have to be used instead. In fact, due to the laws of circuitry that govern all transmission lines, often referred to as Kirchhoff's Laws to those skilled in the art, an interesting phenomenon arises: the marginal cost of meeting a requested electricity demand at designated nodes turns negative due to the resulting reduction of congestion on the electricity grid. In other words, it is more cost effective for the electricity grid to increase loads at designated locations to reduce congestion and allow for the increased use of more desirable generation sources than to perform other solutions.

This phenomenon can be explained by terminology referred to as locational marginal pricing (LMP) to those skilled in the art. Locational margining pricing may be defined as the marginal cost of supplying the next increment of electricity demand on an electric power network at a specific location (node), taking under consideration the bids of both generation sources and demand, in addition to the operational constraints of the transmission network. Such a simplified electricity network appears in FIG. 1.

FIG. 1 shows an example is to represent the importance of the problem and the proposed solution. This problem is known as a transmission congestion issue. Let us assume that generation source 101 has infinite generation capacity at $2 per MWh (Megawatt-Hour). Let us assume that generation source 102 has infinite generation capacity at $20 per MWh. Let us assume that load demand 103 is for 200 MW (Mega-Watt) at the lowest price possible, and that the load demand 104 is 0 MW. Let us additionally assume that the transmission line 108 between nodes 106 to 107 is constrained such that only 50 MW of electricity may be flowing at a time, at maximum. Let us also assume that the impedance of the transmission lines between each node is equal.

In the stated scenario, 150 MW may be provided by generation source 101, with 100 MW flowing through transmission line 110 between nodes 105 to 107, and 50 MW flowing through transmission line 109 between nodes 105 to 106 and subsequently through transmission line 108 from nodes 106 to 107, taking into account Kirchhoff's Laws. The remaining 50 MW of demand must be served by the more expensive generation source 102. Thus, the total cost for load demand 103 is $2/MW*150 MW+$20/MW*50 MW=$1300 per hour under the proposed scenario. Explicitly, the reason for the cost lies in the transmission bottleneck constraint on line 108 with power flowing from nodes 106 to 107.

Let us examine what would happen if an incremental load of 10 MW was added for load demand 104 at node 106. In this case, generation source 101 may increase its generation by 15 MW, with 10 MW additional flowing from node 105 to 106 through transmission line 109 to meet load demand 104, and transmission line 108 between nodes 106 and 107 still constrained at 50 MW. The remaining 5 MW of increased generation from generation source 101 is allowed to flow from nodes 105 to 107, reducing the need for generation source 102 equally. Thus, the total cost for load demand 103 is now $2*155 MW+$20*45 MW=$1210 per hour under the proposed scenario. The system cost for serving load demand 103 has dropped from $1300 per hour to $1210 per hour (a difference of −$90/h) as a result of increased usage at node 106 by load demand 104 of 10 MW. In other words, the locational marginal pricing of serving an incremental 1 MW demand at node 106 is (−$90/h+10 MW)=−$9 per MWh. The general terminology is known as negative LMP when the pricing is below $0/MWh and positive LMP above $0/MWh.

Existing transmission congestion solutions include reducing electricity pricing to end-users to encourage increased load at particular times, or using capital-intensive energy storage mechanisms such as pumped hydro or batteries to store energy. Encouraging increased load may only work to a certain extent once needs have been met, and capital-intensive energy storage mechanisms may be at capacity or not available altogether.

At present, proven, effective, and reliable solutions for congestion mitigation and LMP exit, including:
Managing operations
Mitigation through infrastructure upgrades
Adding new infrastructure¹. ¹ http://www.energy.ca.gov/2011publications/CEC-500-2011-007/CEC-500-2011-007.pdf 2.3.4

Demand response programs, power flow control devices, and reconductoring lines are some of the myriad of solutions available to power grid companies. Each of these are time- or resource-intensive solutions. With system upgrades or adding new infrastructure, significant time and resources are spent running contingency analyses. Often times, these simulations cannot predict the future uncertainties. Thus, even with significant forecasting efforts, power grid needs change unpredictably. If using existing grid infrastructure, the LMP/transmission congestion issue may lead to suboptimal energy consumption due to the constraints imposed.

While clearly wasting energy via resistor banks or the like is still beneficial when viewed at the macro level, there exists a need for a better system alternative that uses existing infrastructure in a more optimal fashion to reduce transmission congestion. In practice, no solution to date has utilized flexible, on-demand load sources that generate financial benefits from scenarios such as the increased electrical load at node 106 to reduce transmission congestion. The limitations of existing solutions is that they are either too complex or require substantial time and resources to execute. Furthermore, the solutions are intended as temporary measures and the grid and demand profiles are constantly changing.

Thus, there is a need for such a capability for utilizing an indirect form of energy storage without the associated capital requirements by using already available, partially, or completely idle computational resources at designated nodes. Moreover, there exists a need for a solution that greatly reduces the complexities associated with a contingency analysis required for many system upgrades.

The proposed solution has a preferred embodiment utilizing distributed computing and blockchain mining technologies and the prior art is discussed below.

Blockchain mining is a critical process to making cryptocurrencies such as Bitcoin more secure. Blockchain mining is also known as consensus protocols or consensus platforms. Blockchain mining distributes trust and controls the security and validity of cryptocurrency networks, new coin releases, and alleviates the reliance of centralized validation networks.² Blockchain mining relies on a distributed public ledger, which adds and verifies new transaction records while also maintaining a database of all prior transactions. New cryptocurrency coins are released in a unit known as a block from an unmined pool of existing coins. The unmined pool can be in the tens of millions of coins and the block can be fractions of a coin or can be multiple coins. All mining is done anonymously without the need of any kind of centralized authority. ² http://www.blockchaintechnologies.com/blockchain-mining

Often times, the mining difficulty for a set denomination of coin currency is set to an approximate time, such as ten minutes, in order to maintain system stability and ensure that the validation process is thorough. The blockchain proof-of-work (PoW) process is a method that ensures the new block was difficult to make, meaning costly in time and energy. The difficulty of the mining dictates the target value of the block. A workflow process begins with proposing a new block, combining and algorithmically hashing the block, and when the hash value is less than the target value, the PoW is deemed solved and a reward provided to the miner in the form of new coins.

Blockchain mining requires sophisticated software and hardware to operate. The software is standardized, however, hardware is a supporting and necessary addition to ensuring blockchain operations are successful. Mining hardware can be as small as an at-home personal computer (PC) or can be custom application-specific integrated circuit (ASIC) mining chips. Both existing computers and dedicated infrastructure setups are used for mining operations. The larger the mining operation, the more profitable it becomes, however, the distributed architecture allows blockchain to run on virtually any computational device worldwide. Mining software exists for all platforms, and is also available as distributed cloud systems³. Thus, a wide variety of existing and new dedicated hardware and software systems are available for mining operations. ³ https://www.bitcoinmining.com/bitcoin-mining-software/

Blockchain mining operations often face the difficulty of finding cheap, available electrical energy sources and the largest mining operations achieve the greatest financial benefit from wholesale electricity pricing rates. Mining operations running from residential or business locations often do not get the same opportunities as larger energy users who may be able to negotiate pricing deals with utilities.

Blockchain PoW processes require energy, and they convert electrical energy from the computational work required into virtual potential energy in the form of a financial transaction confirmation (PoW) which can be considered a form of virtual energy storage. Thus, blockchain mining may be considered an indirect form of energy storage, where the energy is returned not to the grid, but to a client or customer in the form of money.

Blockchain technology is becoming increasingly popular in industry segments such as finance, however, they still have limited exposure to the power industry. Suggested applications include reliable mesh-networks to monitor and control tap changers in geographically remote areas, currently tested in Australia by long-range wireless network company Filament⁴⁵. Filament uses blockchain as a “ledger of things” where tens of thousands of utility poles collect data via sensors and communicate the data to another device, computer, or person, continuously tracking everything. Their electronic accounting system is known as a “Blocklet” and builds upon blockchain to provide autonomous, decentralized methods for commercial transactions. This is an application of blockchain and still requires a PoW process. ⁴ http://fortune.com/2016/05/15/blockchain-reinvents-power-grid/⁵ https://filament.com/technology/

Another company, Lo3 Energy, proposed the TransActiveGrid⁶ idea as a decentralized grid topology with a distributed transaction mechanism provided by blockchain. These local energy markets develop after consumers and vendors have a secure and reliable system of maintaining records of payments⁷. ⁶ http://transactivegrid.net/⁷ http://webcache.googleusercontent.com/search?q=cache:aXEGhihlaKIJ:www.the-blockchain.com/2016/07/20/blockchain-driven-smart-grids-ca-decentralise-the-energy-marketplace/+&cd=4&hl=en&ct=clnk&gl=us

Other small examples include selling solar power at full wholesale premiums in Brooklyn, N.Y.⁸, Accenture developing Smart Plugs that search for energy prices and use blockchain to switch suppliers when more inexpensive sources are found, confirming renewable energy credit transactions to non-qualified energy producers, and German utility RWE charging consumers for energy consumed when charging electric vehicles⁹. ⁸ http://technical.ly/brooklyn/2016/07/07/blockchain-solar-microgrid-npr/⁹ https://papers.ssrn.com/sol3/papers.cfm?abstract_id=2885335

With all the solutions to LMP transmission problems today, no solution allows for an adaptive, dynamic utilization of power that is time or location-independent. Blockchain and distributed computing technologies enable such a solution to exist.

### SUMMARY OF THE INVENTION

The proposed scenario shows that while wasting energy at particular points on the electrical network may be beneficial from a cost perspective to the system, generating utility (useful work) from a computationally intensive process can be derived from the increased electrical load at node 106 to reduce transmission congestion. Select embodiments of these computationally intensive processes may include, but are not limited to, blockchain mining, complex scientific simulations, cloud-based services, or energy-intensive distributed computing problems. A preferred embodiment, blockchain mining, is detailed in this summary to demonstrate the novelty of the invention. To those skilled in the art, however, such explanation extends to any such computational intensive process that may generate utility.

Blockchain technology represents such an alternative to increasing load while performing useful work on demand. Blockchain is a technology proposed by Nakamoto in a paper titled “Bitcoin: A Peer-to-Peer Electronic Cash System” on May 24, 2009 (http://bitcoin.org/bitcoin.pdf). Blockchain technology relies on a proof-of-work (PoW) system in which processor (CPU) effort is expended to satisfy a cryptographic algorithm or puzzle, incorporating transactions within the network when such energy is used. The proof-of-work is simple to verify by other nodes on the network, and is linked to the previous completed proof-of-work block on the network, hence the terminology of blockchain. The only mechanism by which to alter a block is to redo the associated CPU work, which is seen as a form of energy expenditure.

The creation of such blocks may be rewarded by transaction fees, or other financial incentives such as the awarding of a virtual currency (e.g. Bitcoin) by agreed upon rules within the network. Because of the distributed nature of such computations and the system, nodes are free to connect and disconnect at will to perform services for the blockchain network, only reaping the rewards when connected.

To those skilled in the art, such a distributed architecture to support the recording of transactions by those on the network when CPU power is available is novel. In fact, the inventor of the blockchain describes such architecture as allowing for the expense of CPU time and electricity to be “analogous to gold miners expending resources to add gold to circulation.”

Thus, fitting examples for utilizing mining technology include situations where LMP is negative at a particular node, or the price of electricity is abnormally low or negative due to other system constraints/incentives. For example, generation constraints such as to keep a nuclear power reactor running or obtain subsidies for renewable generation. In the aforementioned examples, blockchain mining can be used to perform useful work and replaces wasting the associated energy with performing useful work. Thus, blockchain mining allows for an indirect form of energy storage without the associated capital requirements, but rather using already available, partially or completely idle computational resources at designated nodes.

For instance, if the system operator for the transmission system of the electric grid in the area informed a utility of negative LMP at certain nodes, the utility may be able to immediately increase load by connecting to the network and performing services for the blockchain network through PoW using its own idle computational resources, gaining transaction fees or a virtual currency in return. Alternatively, the utility may have arranged for software to be installed on idle computational resources of its customers, whether residential or commercial, such that mining is automatically commenced over a network connection when determined to be beneficial by the utility/system operator, with cost benefits and expenses of such an architecture shared between the included parties. Regardless, to those skilled in the art, such a solution represents a promising alternative to wasting energy or implementing capital intensive technologies due to transmission line constraints or other operating constraints/incentives within the electrical network.

To those skilled in the art, such explanation only represents some embodiments of the invention, and is to encompass all uses of blockchain technology to facilitate the operation and value provided by the electric network.

To those skilled in the art, the method described can also be seen as beneficial in situations where energy certificates are issued or cap-and-trade is implemented or where fines are implemented for not meeting designated generation profiles. For instance, in the United States, many states/territories have a renewable portfolio standard (RPS) where generation from designated types of sources may have to be met. This goal is often met by the issuance/generation of renewable energy certificates (RECs) for every unit of clean energy produced or sold, which ‘dirtier’ generation entities may be required to purchase to avoid fines or to continue operating.

In other cases, a cap-and-trade program may be present where cleaner sources of energy generate credits for their cleaner generation which can be sold in a market to allow ‘dirtier’ sources of generation to continue operating. In the United States, a program under consideration to impose carbon generation limits at the state level is referred to as the Clean Power Plan (CPP). To those skilled in the art, the value of such certificates, credits, or fines also influence the LMP at any given point within the electrical network. The proposed solution can thus be readily applied to aid in achieving an improved outcome versus wasting energy where LMP prices may be low or negative in part due to governmental or community imposed standards for power generation via credits or certificates or potential penalties or the like.

The disclosed method also includes a novel architecture by which to coordinate and manage computational resources available to consume power and generate value upon being commanded to do so by the utility or other central authority. In one embodiment, the method includes using designated protocols to ‘wake up’ idle computational resources in a lower power state so as to consume more power. In another embodiment, the method includes protocols to communicate to slave computational resources from a master computational resource that may be exposed to such command signals. In another embodiment, the method includes protocols to communicate a reward or price-based activation signal by which computational resources may elect to participate or not at a given time depending on their own constraints or preferences. In another embodiment, the method includes computational resources communicating to peer computational resources the presence of a command, reward, or price-based activation signal instead of receiving such signals directly from a central authority, which may or may not have trust enhancing features such as hashes or security keys to prove authenticity of such signals.

In another embodiment, the method also includes a prioritization or ranking by which to initiate mining or increased computation on such computational resources based on their efficiency and other constraints. For example, differing computational resources may have different startup and shutdown times for joining the network, or may be able to boost computational power at a faster rate, or may perform more computation of value to the network per unit of energy compared to its peers.

In one embodiment, the mining devices are existing infrastructure found in residential, business, and commercial customer loads. They may be existing PCs and idle servers which spare processing power. Plug loads, such as cell phones or tablets, may also be used. Internet-of-things (IoT) loads, such as smart appliances, may also be used. Loads may be prioritized, meaning, some loads can be chosen to work first before others. The communication may be one-way, in order to allow the utility to ping the distributed network for available capacity, or two-way, where the distributed network can also ping the transmission grid for available congestion- or price-relief solutions. The utilization of existing infrastructure eliminates the burden of upfront capital investments, and reduces the LMP problem to a control, software, and communications problem. Program enrollment may be open to any and all energy customers. Thus, distributed mining operations empowers grid customers to make a positive energy, economic, or environmental impact and can be used as a customer relations and enrollment tool by utility companies to create as much distributed energy resources as possible at each transmission grid node.

While the preferred embodiment utilizes existing infrastructure, it is also possible to integrate or exclusively use new infrastructure that is able to perform mining operations. This new infrastructure may reduce the benefit of no upfront capital investment, however, it may be a useful for specific applications or if a business case is developed for including new infrastructure.

At one given time, it may be most valuable to the network to get consumption up as soon as possible without regards for local energy efficiency, yet at another time a long-term outlook may result in a desire to get the most efficient computational sources joined first. Efficiency-based utilization can change to inefficient utilization if it is required. For example, if an existing cluster of computers are currently in use by users, an efficiency profile is set. When the users leave, the inefficient utilization of max power can be used.

In a preferred embodiment, the location of the distributed computing nodes is associated with a grid node, so that an estimation can be calculated for the amount of available load, per node, at any given time. The location, magnitude, and temporal availability of the nodes is important in order to get a fair estimate of the LMP impact available. When the power grid is smaller, such as in the case of a microgrid, understanding the node location on the grid network is even more critical, and thus methods should be performed to ensure accurate and precise measurement of node location, available energy levels, and time available for load utilization.

Similarly, thermal constraints from extended operation (e.g. excessive heat) or ambient conditions may influence participation as well, with nodes disconnecting when limits are reached. Thermal constraint calculations can include heating, ventilation and air conditioning (HVAC) requirements, such as a calculation for the excess heat generated by utilizing computer resources and the necessary associated cooling requirements.

Asset life can be included in the decision to use the distributed computing resource. If an asset has a limited number of cycles available, the asset may be used with less intensity to allow for a longer total asset life span.

In another embodiment, end users may override the contribution of their computational resources to the program, possibly incurring a penalty or revocation of an agreed-upon benefit with the utility or other authority. In another embodiment, particular types or components of the computational resources may be prioritized differently due to their differing computational capabilities for the assigned tasks, such as graphics processing units (GPU) or application-specific integrated circuits (ASIC). Many central processing units (CPUs) and GPus have different energy state modes, such as a low-energy efficient and high-computation, energy-intensive mode, and these modes can be utilized for the PoW calculation.

In yet another embodiment, in the event of a loss or disruption of a network connection, for example from continued packet loss or a cyberattack or the like, computational resources may stop contributing to the requested increased electricity consumption commands issued and return to an idle or lower power state until such connection is satisfactorily resumed.

Another embodiment also includes computational accounting methods by which participation may be accounted for in order for participants and the commanding entity to share the rewards. For example, in the absence of smart meters, it may not be possible for the exact contribution of a particular computational resource to be tabulated, but it may be possible on an aggregate level where a proportion of the rewards are distributed based on computational power and duration of the contribution. Similar systems exist for household utilities, for example, where unit-level water/sewer usage may not be implemented. In yet another embodiment, the network connection may be wired or wireless in nature, such as over radio networks, cellular data networks, or even via traditional systems such as a phone or fax connection.

### BRIEF DESCRIPTION OF THE DRAWINGS

The drawings are meant only to help distinguish the invention from the prior art. The objects, features and advantages of the invention are detailed in the description taken together with the drawings.

FIG. 1 is a representation of a transmission grid with capacity constraints and locational marginal pricing.

FIG. 2 is an exemplary process diagram of utilizing a distributed computing resource during a qualified power grid event.

FIG. 3 is an exemplary power system with distributed computing resources.

### DETAILED DESCRIPTION OF THE PREFERRED EMBODIMENTS

Even though the invention disclosed is described using specific implementation, it is intended only to be exemplary and non-limiting. The practitioners of the art will be able to understand and modify the same based on new innovations and concepts, as they are made available. The invention is intended to encompass these modifications.

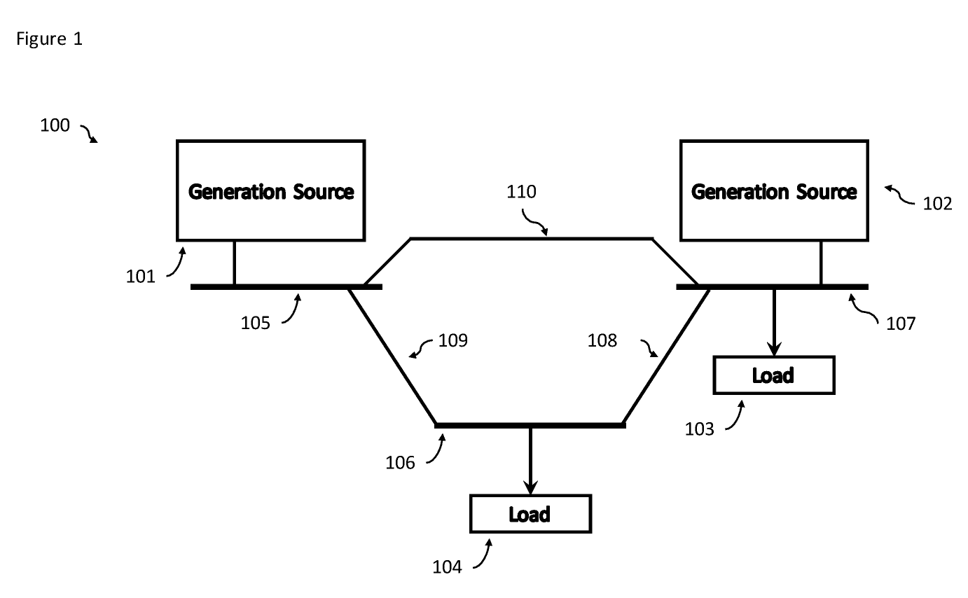

FIG. 1 shows an example transmission grid 100 with power generation sources 101 and 102. Nodes 105, 106, and 107 are connected together with transmission line 108 connecting nodes 106 to 107; transmission line 109 connecting nodes 105 to 106; and transmission line 110 connecting nodes 105 to 107. Power demand load 103 is found at node 107, and power demand load 104 is found at node 106. Loads 103 and 104 are example aggregate loads found from a combination of residential, commercial, and industrial applications typical of a power grid utility customer base. They may have an hourly, weekly, monthly, and annual pattern to their demand profiles. Nodes 105, 106, and 107 may be transmission grid interconnection points, substations, or other connections for transmission or distribution lines. Generation sources 101 and 102 can be any time of power generation source, such as conventional or non-convention energy resources, including, but not limited to, thermal, wind, solar, nuclear, and hydro-based energy sources. Transmission lines 108, 109, and 110 can be any AC or DC power transmission line of any voltage level applicable to a power system.

The example transmission grid 100 may operate by any number of economic models, and can be a fixed, bidding-based, or hybrid model for the control and selection of generation and transmission resources. Pricing for the generation resources 101 and 102 are based on one of any number of factors, such as fuel source, resource availability, operation and maintenance costs, or other energy generation pricing factors. Power demand loads 103 and 104 may be on fixed or variable pricing, and for this example can represent one of many loads available at each node, or can be an aggregate of loads with an averaged pricing per unit time. Transmission lines 108-110 may have a fixed or variable capacity that may change based on various power quality, thermal, and other regulations. Nodes 105-107 may also have fixed or variable capacities based on various regulations, and may include power flow controllers or other devices available to modify and manipulate the power factor and power quality of parts of the system 100.

Generation sources 101-102, nodes 105-107, and transmission lines 108-110 may have various temporally-based pricing models impacted by loads 103-104. The pricing can be based on one of any number of variables, such as the current demand levels, transmission capacity constraints, commodity costs, and power generation source investment and operating costs. Nodes 105-107 have LMP nodal pricing calculations, which can be calculated in one of any number of methods, such as day-ahead, integrated forward market, and other methods. Congestion in nodes 105-107 is typically defined by power capacity constraints, such as maximal power flow allowed to flow along a line in a given amount of time.

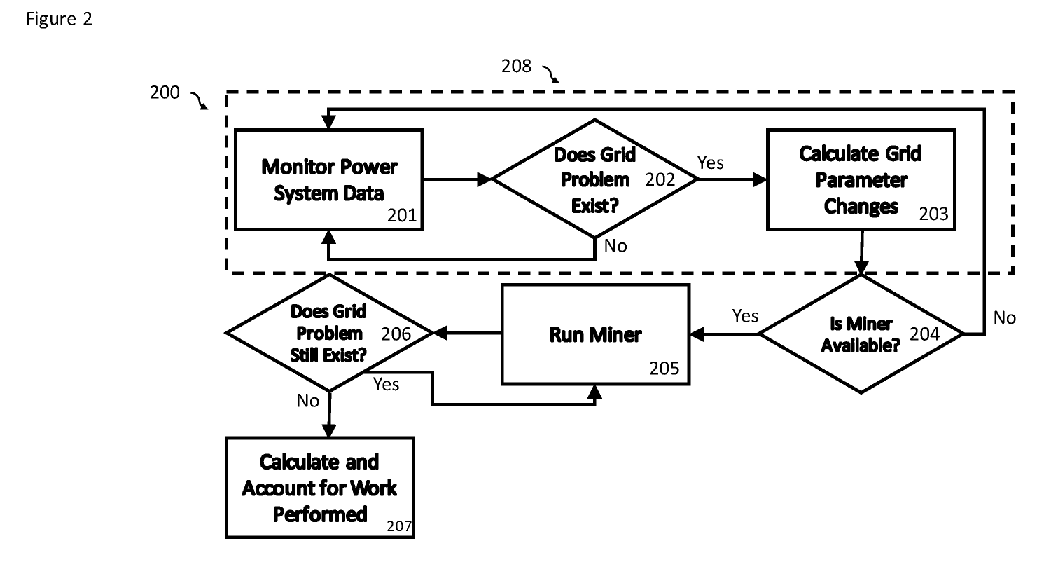

FIG. 2 represents a process diagram 200 for a generic blockchain mining system integrated with a power system. The process begins with monitoring power system data 201. Power system data may include, and is not limited to, LMP at various nodes, transmission constraints, generation data, and power demand. Power system data can be actual or forecast, and may include predictions of future states. Conditional logic block 202 determines if a problem exists, in this case it is an LMP problem. If an LMP problem exists, such as the one previously defined where LMP becomes negative, then the logic block moves forward through the blockchain miner process 200. Conditional logic block 202 can search for any number of problems, including LMP, pricing arbitrage, grid congestion, a sudden drop in power demand, and more. In the LMP problem example, if an LMP problem exists, then functional block 203 calculates the grid parameters to change, in this case the change in LMP values and associated prices.

Functional logic combination 208 consists of the generic monitoring, problem discovery, and parameter calculation, and can be any one of a number of solutions, such as an energy management system, custom installation, cloud-based controller, or dedicated system. It would be advantageous to be controlled by a grid operator or a third party, however, any reputable authority can be in charge of managing the monitoring 201, calculation 202, and state changes 203 functions. The responsibility can be from different groups if it is deemed applicable.

Conditional logic block 204 checks if mining capacity is available. Mining capacity can be defined by the total amount of energy available per unit time per power system node, or any other suitable calculation such as a price or reward-based activation signal based capacity. Mining capacity can be either distributed or centralized, however, in the preferred embodiment, mining capacity is distributed and utilizes existing infrastructure so as to avoid the construction of new, capital-intensive infrastructure. Mining capacity can exist of any of a number of combination of new and existing devices, and can be cloud-based, PCs, dedicated computing clusters, and anything else able to perform mining operations.

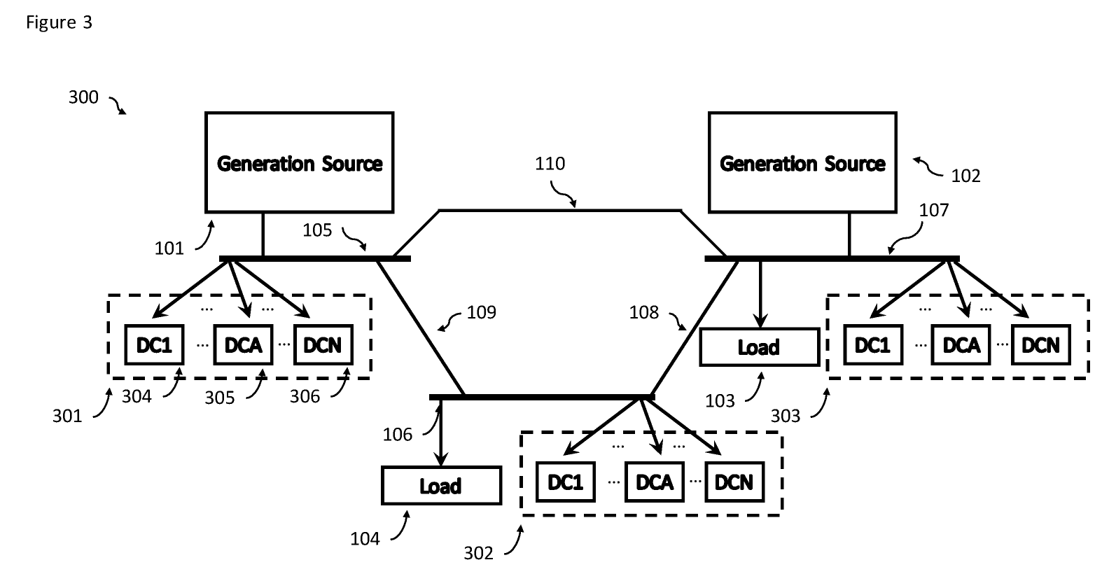

Functional logic block 205 runs the miner if it is determined by conditional logic block 204 that mining capacity is available if by functional combinational logic block 208 that a grid problem exists. Miner 205 can be any type of energy-consuming operation that utilizes electrical energy to perform digital calculations of energy-intensive processes, such as blockchain mining, blockchain identity verification, complex scientific simulations, Amazon Web Service (AWS)-like instances that start up on demand, random number generators, decoding genomes, encryption algorithms, decryption algorithms, or any other energy-intensive process that converts electrical energy into useful work that can be used for value. In the preferred embodiment, the miner is a blockchain miner and acts in a distributed manner, as shown in FIG. 3 by distributed computing resource blocks 301, 302, and 303.

Functional logic block 205 runs the computationally intensive process, in this case a miner, for a unit of time. Functional logic block 205 can alternatively or in addition issue price or reward based activation signals by which devices or computational resources may elect to participate. The capacity may be fixed or variable, and the devices may turn on or off at any time without affecting the overall constraints of the system, namely, performing calculations and expending electrical energy by a predetermined amount. The miner may change capacity at any time for any reason, either from feedback by the power utility, or from miners deciding to turn off their computing resources for any reason, including changes in reward or financial incentives to participate. In more critical applications, miner owners may provide a guarantee to keep their resources available and may hand control of the computational power over to the power utility. Some, none, or all of the resources can have this additional constraint. Conditional logic block 206 monitors the grid problem and checks if the grid problem still exists. The monitoring system can be command-based, such as the power utility providing a command informing the mining resources that capacity is no longer needed, or it can be any number of other monitoring methods. A dedicated tracker, for example, can be monitoring power supply, transmission constraints, and demand, and determine independently that grid problems no longer exist.

Once the grid problem no longer exists, mining resources can either be turned off or left on, based on the needs of the system, including by modification of a reward or price-based activation signal. Regardless of the time after the grid problems finishes, there may be an optional functional step 207 to calculate the amount of work performed. In the preferred embodiment, once a blockchain mining operation successfully completes, there may be financial earnings and revenue that require calculations. The revenue can be shared amongst the participants and power utility in a predetermined, mutually beneficial arrangement. For example, if work was performed for one unit of time, and one Bitcoin was awarded, the miner may be given half a bitcoin for its participation in the grid problem mitigation effort, and the power grid utility may receive half a bitcoin for providing the infrastructure and communication services to notify the miner of the opportunity. Furthermore, the power grid utility may allocate the half Bitcoin reward to specific, geographically-based infrastructure that was utilized in the grid problem mitigation effort, so as to compensate the specific infrastructure for its operational and maintenance costs and to save for future costs associated with the same infrastructure.

FIG. 3 represents the same power grid system 100 with distributed mining operations and is denoted as combined power grid system 300. Distributed computing resource clusters, or nodes, 301-303 are connected to their respective grid nodes 105-107. An example distributed computing (DC) node 301 consists of distributed computing resources available for node 105. Distributed computing resources are DC1 304, representing the first resource, DCA 305, representing the A-th computing resource, and DCN 306, representing the N-th computing resource. DC1, DCA, and DCN for nodes 301-303 are different for each node and are not related in any way except for the fact they are all distributed computing resources.

A DC resource can be any of the aforementioned resources for distributed computing resources or for mining capacity. A DC resource can itself be a centralized or distributed resource, meaning it can consist of its own cluster of distributed resources or can be a single computer, for example. In the preferred embodiment, DC resources are distributed and utilize existing infrastructure so as to avoid the construction of new, capital-intensive infrastructure. DC resources can exist of any of a number of combination of new and existing devices, and can be cloud-based, PCs, dedicated computing clusters, and anything else able to perform computational operations.

A resource cluster such as cluster 301 can be connected to a transmission node 105 and thus be able to serve as an on-demand load source at node 105. When a negative LMP problem exists, cluster 301 can be called upon using the workflow process 200 to alleviate or eliminate the LMP problem. Such commands or activation signals may be communicated within or among clusters independently from a central authority. The clusters themselves or a separate system, not shown, can calculate any revenue share agreed upon by all participating parties in the power grid with distributed mining operation system 300.

1. A method for power grid balancing, comprising the steps of:
analyzing the data of a power system with at least one node to determine whether a power grid problem exists; and
coordinating the control of at least one distributed computing resource associated with the at least one node, to mitigate the grid problem.

2. A method according to claim 1, wherein the power system data includes at least one of a power node location, power demand at the power node location, power flow magnitude at the power node location, maximum power flow allowed through the power node, and locational marginal price of electricity at the power node.

3. A method according to claim 1, wherein the control of at least one distributed computing resource further comprises the steps of:
determining the availability of the distributed computing resource;
calculating a reliability level for the distributed computing resource;
associating an energy and financial cost to run the distributed computing resource; and
prioritizing the distributed computing resources based on any of the aforementioned steps.

4. A method according to claim 1, wherein the grid problem is a negative locational marginal price event.

5. A method according to claim 1, wherein the distributed computing resources increase power consumption levels by running blockchain distributed ledgers to mitigate or eliminate the grid problem.

6. A method according to claim 1, wherein the distributed computing resources are financially rewarded based on the calculated amount of work performed during the grid problem event time.

7. A method according to claim 1, further comprising a financial reward for mitigating or eliminating the grid problem, the financial reward being shared between the owner of the distributed computing resource and at least one other party participating in the operation of the power grid.

8. A method according to claim 1, wherein the distributed computing resources;
receive an activation signal; and
determine a participation level for work to perform based on the activation signal.

9. A method according to claim 1, wherein the distributed computing resource has a specified network architecture to allow for communication and control of the available computational resources, comprising:
a priority metric approach based on system constraints;
a fairness metric so that resources can be equally utilized in terms the priority metric;
an accounting method to allocate credit among distributed computing resource participants;
a recovery module to recover from system connectivity disruptions;
a thermal adjustment metric to account for thermal losses when running the distributed computing resource; and
a power grid node location associated with the distributed computing resource.

10. A power grid comprising:
a plurality of distributed computing resources at a number of power grid node locations in the power grid, each having;
a controller for control of the distributed computing resource and for communication with the other distributed computing resources within a local group of distributed computing resources to enable coordinated response of the other distributed computing resources within the respective local group of distributed computing resources;
a processor that receives a control signal from the controller and reacts by performing a computational procedure; and
a transceiver for communication with the controller to receive commands to start and stop the processor, to communicate the outcome of the computational process and to receive instructions and associated data for new computational processes.

11. The power grid of claim 10, wherein the plurality of distributed computing resources are grouped into nodes, and each of the plurality of distributed computing resources being associated with at least one power grid node.

12. The power grid of claim 10, wherein the power grid has at least one of a locational marginal price, power transmission or distribution line, energy generation source, distributed computing resource, and power demand load.

13. The power grid of claim 10, further comprising a computational process run by the distributed computing resource, wherein the computational process:
performs a blockchain proof of work calculation;
has an associated financial reward;
wherein the associated reward is shared between the owner of the distributed computing resource and at least one other party participating in the operation of the power grid.

14. The power grid of claim 10, wherein the distributed computing resources run computational operations to consume power during negative locational marginal pricing events and reduce or eliminate the negative locational marginal pricing event.

15. The power grid of claim 10, wherein the plurality of distributed computing resources utilize their excess capacity during grid events by asynchronously accepting computational work requests.

16. A computer-readable medium having computer-executable instructions for a method for power grid balancing, comprising the steps of:
receiving, over a network, a plurality of power system data over time of at least two power system nodes;
determining, using at least one computing device, the locational marginal price of the at least two power system nodes;
determining, using at least one computing device, whether a more suitable combination of locational marginal prices can be achieved;
calculating grid parameter changes required to fix the grid abnormality;
coordinating the control of at least one distributed computing resource associated with the power system node; and
transmitting an activation signal to the distributed computing resource.

17. The computer-readable medium of claim 16, further comprising the steps of:
calculating the availability of the distributed computing resources;
recalculating the locational marginal price of the at least two power system nodes to see if a beneficial change occurred; and
calculating the amount of work performed by the distributed computing resource during the grid problem event time.

18. The computer-readable medium of claim 16, wherein the power system data includes at least one of a power node location, power demand at the power node location, power flow magnitude at the power node location, maximum power flow allowed through the power node, and price of electricity at the power node.

19. The computer-readable medium of claim 16, wherein the distributed computing resources run blockchain distributed ledgers to mitigate or eliminate the grid problem.

20. The computer-readable medium of claim 16, wherein the distributed computing resources are financially rewarded based on the calculated amount of work performed during the grid problem event time.
